(19) United States
(12) Patent Application Publication
(10) Pub. No.: US 2010/0131683 A1
(43) Pub. Date: May 27, 2010

(54) SYSTEM FOR STORING, ACCESSING AND AUTOMATICALLY UPDATING DOCUMENTS

(76) Inventors: CLAY S. MOORE, Kirkland, WA (US); Gabriel R. Nodland, Kansas City, MO (US)

Correspondence Address: PATENT GROUP;C/O DLA PIPER US LLP, 203 N. LASALLE ST., SUITE 1900, CHICAGO, IL, 60601, US

(21) Appl. No.: 12/323,901

(22) Filed: Nov. 26, 2008

(51) Int. Cl. G06F 13/00; G06F 12/00; G06F 3/00

(52) U.S. Cl. 710/63; 710/74; 711/115; 711/E12.001

(57) ABSTRACT

Systems and processes are provided that relate to storing, accessing, searching, and automatically updating of secure documents stored on a USB device. The systems and processes include a USB device that stores a document set, a web service that provides updated documents for the document set, and a content management application that uploads the updated documents to the web service.

### BACKGROUND

The systems and processes disclosed herein relate generally to accessing, searching, and automatically updating of documents stored on a transportable device. More particularly, the systems and processes disclosed herein relate to the utilization of universal serial bus (USB) technology to allow users to store, access and update documents.

USB drives generally consist of a memory storage device, such as a flash memory, that is integrated with a USB interface. The USB interface allows the USB drive to be connected to any computer that has a USB port. Typically, a USB drive includes a small printed circuit board that is protected inside a plastic, metal, or rubberised case. Often, a USB drive is designed to be carried in a pocket, or on a lanyard or keychain. The USB interface can be protected by a cap or lid, or is sometimes designed to retract into the case of the USB drive when not in use. Computers read and write USB drive data using the same system commands as for a mechanical disk drive, with the storage appearing to the computer operating system and user interface as just another drive.

### BRIEF SUMMARY

The systems and processes disclosed herein relate to storing, accessing, and automatically updating documents in a stored document set. The systems and processes described above preferably allow a user to store a document set on a USB device, access the document set from any computer equipped with a USB port, and automatically update the document set when the computer is connected to the Internet.

In one aspect, a system for storing, accessing, and automatically updating documents in a stored document set is provided that includes a USB device adapted to store a document set, a web service adapted to communicate with the software application on the USB device; and a a content management application. The USB device includes a memory and a software application. The web service is adapted to provide master copies of documents to the USB device to update the document set. The content management application uploads the master copies of documents to the web service.

In another aspect, a system for storing, accessing, and automatically updating documents in a stored document set is provided that includes a USB device including a memory and a software application, a computer that is connected to the USB device and to the Internet; a web service that includes a master copy of each document in the document set stored on the USB device, and a content management application that uploads the master copies of documents to the web service. The USB device stores a document set and each document in the document set includes a version identifier. The computer is connected to the Internet. The web service communicates with the software application on the USB device when the USB device is connected to the computer and the software application is launched, and provides the master copy to the software application of the USB device when the master copy has a more recent version identifier than the version identifier of the document on the USB device.

In a third aspect, a process for automatically updating documents in a document set stored on a USB device is provided that includes: connecting the USB device to a computer, where the USB device stored a document set and includes a browser; launching the browser of the USB device; connecting the browser of the USB device to a web service; and updating any outdated document in the document set on the USB device based upon master copy versions of each document stored by the web service.

### BRIEF DESCRIPTION OF SEVERAL VIEWS OF THE DRAWINGS

Specific examples have been chosen for purposes of illustration and description, and are shown in the accompanying drawings, forming a part of the specification.

FIG. 1 illustrates a system for storing, accessing., and automatically updating documents.

FIG. 2 illustrates a flow diagram for automatically updating documents using the system of FIG. 1.

### DETAILED DESCRIPTION

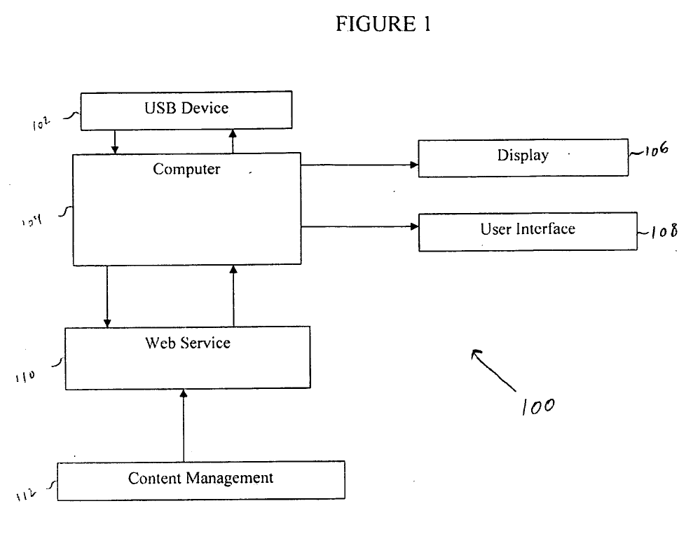

FIG. 1 illustrates one example of a system for storing, accessing, and automatically updating documents, the system being designated generally at 100. The system 100 includes a USB device 102, a computer 104 that has a display device 106 and user interface device 108, a web service 110, and a content management application 112.

The USB device 102 includes memory and a software application that can be launched from the USB device 102 when the USB device 102 is connected to the computer 104 via a USB port (not shown). The USB device 102 can be marked electronically to allow the software stored on the USB device 102 to verify that it is being launched from an authorized USB device 102.

The USB device 102 can be provided to a user with an initial document set stored in the memory of the USB device 102. The initial document set can include, for example, one or more documents in an electronic format. Preferably, the one or more documents in a document set are in a searchable format. In one example, an initial document set can be provided that includes one or more documents in a portable document format (PDF), preferably searchable PDF. In other examples, the initial document set can be in other computer readable formats, including, but not limited to html documents, xml documents, and common office formats such as, for example, Microsoft Word®, Excel®, or PowerPoint®. The initial document set can also be encrypted, which can provide a measure of protection against unauthorized access. Alternatively, the USB device 102 does not have to include an initial document set. In such a example, a user could be provided with a USB device 102, and a document set could be transferred from the web service 110 the first time that the user connects the USB device 102 to a computer 104 and launches the software application on the USB device 102 to allow the software application to communicate with web service 110.

As illustrated in FIG. 1, computer 104 includes a display 106 and a user interface 108. Display 106 can be any suitable display device, such as, for example, a monitor. User interface 108 can be any suitable user interface, such as, for example, a keyboard, mouse, touchpad, stylus, or any combination thereof. The computer 104 is preferably connected to the Internet. USB device 102 can connect to the computer 104 via a USB port located on the computer 104. When the USB device 102 and the computer 104 are connected, a user can utilize the user interface 108 and the display 106 to launch the software application on the USB device 102. Alternatively, the computer can automatically launch the software application on the USB device 102 once a user connects the USB device 102 to the computer 104. Once launched, the software application on the USB device utilizes the connection that the computer 104 has to the Internet to communicate with the web service 110 to automatically update any document in the document set that is out of date.

The web service 110 includes a master copy of each document in a document set that is intended to be stored on the USB device 102. The content management application 112 can be utilized by a content manager to upload documents to the web service 110. Preferably, the content management application 112 is a web-based application that can be utilized to upload documents and apply a version designation or identifier to each document. The document management application can also mark which version of a document is the master copy that is ready for publication, or the document management application 112 and the web service 110 can be set up to identify the most recent version of a document as being the master copy. In one example, the content management application 112 allows documents for a document set to be uploaded by a document manager and placed into a directory structure. If desired, new versions, including, for example, updates or revisions, of each document can be created over time, and can be provided to the web service 110 as a new master copy. Any new master copy of any document can then be provided to the USB device 102 and stored thereon through the automatic updating process when the software application on the USB device 102 is launched and communicates with the web service 110.

The software application on USB device 102 is preferably a browser application. The browser launches directly from the USB device 102 and communicates to the web service 110 when the computer 104 is connected to the Internet. The browser can include features including, but not limited to, notation and search. For example, the browser can allow a user to bookmark pages of any document, and preferably to make notes in the bookmark. A search feature can allow the user to search across multiple documents stored in the document set on the USB device 102. The results of a search can preferably appear in a ranked order, and more preferably can also highlight the search term or terms. Search results of tabular data can be presented in tabular form with row headings.

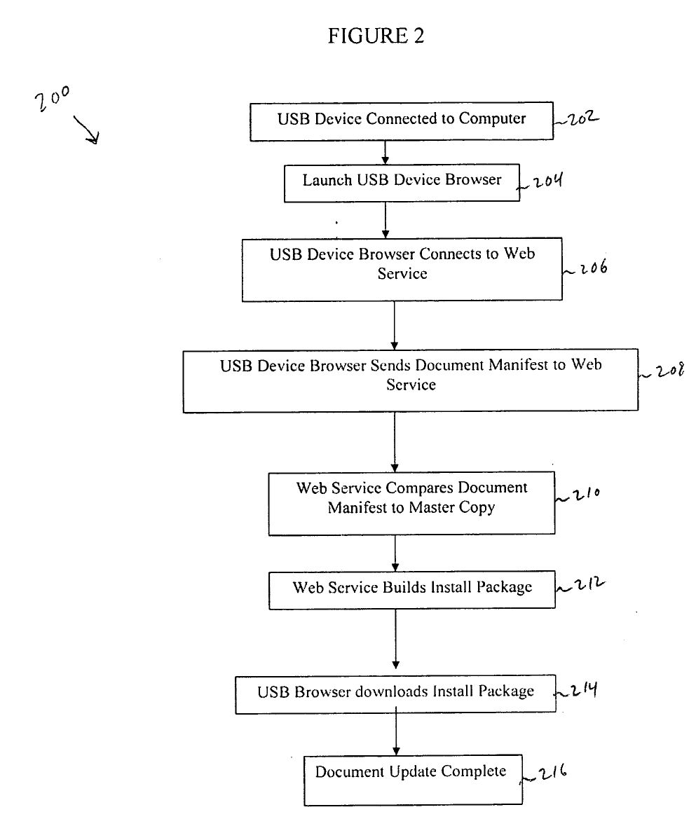

A process for automatically updating documents in a document set to be stored on a USB device is illustrated generally at 200 in FIG. 2. As shown, a USB device can be connected to a computer in step 202, preferably via a USB port. In step 204, a user can launch the software application on the USB device, in this instance the USB device browser. The USB device browser connects to the web service in step 206. The USB device browser then sends a document manifest to the web service in step 208. The document manifest preferably includes the document version identifier for each document currently stored on the USB device. In step 210, the web service compares the document versions in the document manifest to the master copy for each document. In each instance where the document version provided in the document manifest is outdated, and the master copy is a more recent version of the document, the web service will identify that the document should be updated on the USB device. The web service builds an install,package in step 212 that contains the master copies of any documents to be updated on the USB device. Preferably, the builds a single install package containing all of the documents to be updated on the USB device. The web service can then provide the install package to the USB device browser, or otherwise notify the USB device browser to install the more recent master copies. In step 214, the USB device browser receives, or downloads, the install package. Preferably, the USB device browser replaces any outdated documents with the new master copy of that document. In step 216, the automatic document update is complete. Preferably, the automatic updating process occurs each time the software application On the USB device 102 is launched and communicates with the web service 110.

Referring back to FIG. 1, once an automatic document update is complete, a user can utilize the computer 104 to access the document set stored on the USB device 102. For example, the user can use the display 106 and user interface 108 of the computer in conjunction with the software application on the USB device to search the document set or view individual documents in the document set.

### EXAMPLE

A USB device was created that includes a document set relating to compliance with the regulations for shipping dangerous goods. The document set includes the following regulatory information: the Oct. 1, 2006 edition of 49 CFR (Code of Federal Regulations); the 2007 edition of A.I.R. Shipper™; the Emergency Response Guidebook (ERG); the Dangerous Goods Advisor™ for 49 CFR and A.I.R. Shipper™; and a Combined Dangerous Goods List (cDGL). A.I.R. Shipper™ is a reference designed for shippers that has been reviewed and approved by the International Civil Aviation Organization (ICAO), and that was developed in compliance with ICAO standards. The ERG contains the latest dangerous goods lists from the United Nations Recommendations, as well as important emergency information for first responders. The Dangerous Goods Advisor™ contains hazardous materials tables. The cDGL combines dangerous goods entries from US DOT, A.I.R. Shipper™, International Air, and International Maritime to compare the top 25 dangerous goods table entries for all modes of transportation.

The USB device also includes a custom browser that allows a user to access and navigate the document set. The documents in the document set are searchable PDF documents. The browser allows a user to conduct keyword searches of the documents. When a user connects the USB device to a computer that is connected to the Internet, an automatic update process is performed in the manner described with reference to FIG. 2 above, and the documents in the document set can be updated based on any master copies that have been revised or updated by a document content manager.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A system for storing, accessing, and automatically updating documents in a stored document set, the system comprising:
a USB device including a memory and a software application, where the USB device is adapted to store a document set;
a web service adapted to communicate with the software application on the USB device, where the web service is adapted to provide master copies of documents to the USB device to update the document set; and
a content management application that uploads the master copies of documents to the web service.

2. The system of claim 1, further comprising a computer having a display device and a user interface, where the USB device is adapted to connect to the computer via a USB port.

3. The system of claim 1, wherein the USB device is marked electronically to allow the software application to verify that it is being launched from an authorized USB device.

4. The system of claim 1, wherein the USB device is provided to a user with an initial document set stored in the memory of the USB device.

5. The system of claim 4, wherein the initial document set includes one or more documents in a searchable format.

6. The system of claim 4, wherein the initial document set is encrypted.

7. The system of claim 1, wherein a document set is downloaded to the USB device the first time a user connects the USB device to a computer and launches the software application on the USB device to communicate with the web service.

8. The system of claim 1, wherein each document in the document set stored on the USB includes a version identifier.

9. The system of claim 8, wherein a document in the document set on the USB device is updated when the web service contains a master copy of the document having a more recent version identifier than the version identifier of the document on the USB device.

10. The system of claim 1, wherein the software application is a browser.

11. The system of claim 10, wherein the software application allows a user to bookmark a page in a document of the document set.

12. The system of claim 10, wherein the software application allows a user to search the documents in the document set using one or more key words.

13. A system for storing, accessing, and automatically updating documents in a stored document set, the system comprising:
a USB device including a memory and a software application, where the USB device stores a document set and each document in the document set includes a version identifier;
a computer connected to the Internet, where the USB device is connected to the computer;
a web service that communicates with the software application on the USB device when the USB device is connected to the computer and the software application is launched, where the web service includes a master copy of each document in the document set stored on the USB device and provides the master copy to the software application of the USB device when the master copy has a more recent version identifier than the version identifier of the document on the USB device; and
a content management application that uploads the master copies of documents to the web service.

14. A process for automatically updating documents in a document set stored on a USB device, the process comprising the steps of:
connecting the USB device to a computer, where the USB device stored a document set and includes a browser;
launching the browser of the USB device;
connecting the browser of the USB device to a web service; and
updating any outdated document in the document set on the USB device based upon master copy versions of each document stored by the web service.

15. The process of claim 14, wherein the step of updating comprises:
sending a document manifest from the browser to the web service, where the document manifest includes a version identifier for each document in the document set;
comparing the version identifiers in the document manifest to the master copy-versions of each document stored by the web service; and
providing master copies of documents from the web service to the USB device when the version identifier of the master copy on the web service is more recent than the version identifier of the document on the USB device.

16. The process of claim 14, wherein the web service builds an install package containing documents to be updated on the USB device, and the software application downloads the install package.

17. The process of claim 16, wherein the web service builds a single install package.

18. The process of claim 14, wherein the step of updating occurs each lime the browser of the USB is launched and connects to the web service.
